(19) United States
(12) Patent Application Publication
(10) Pub. No.: US 2023/0012643 A1
(43) Pub. Date: Jan. 19, 2023

(54) METHOD FOR PREDICTING C-AXIS LENGTH OF LITHIUM COMPOUND CRYSTAL STRUCTURE, METHOD FOR BUILDING LEARNING MODEL, AND SYSTEM FOR PREDICTING CRYSTAL STRUCTURE HAVING MAXIMUM C-AXIS LENGTH

(71) Applicant: SEMICONDUCTOR ENERGY LABORATORY CO., LTD., Atsugi-shi (JP)

(72) Inventors: Kazuki HIGASHI, Atsugi (JP); Kunihiko SUZUKI, Isehara (JP); Kenta NAKANISHI, Atsugi (JP); Yuji IWAKI, Isehara (JP)

(21) Appl. No.: 17/854,101

(22) Filed: Jun. 30, 2022

(30) Foreign Application Priority Data
Jul. 9, 2021 (JP) 2021-114509
Sep. 9, 2021 (JP) 2021-146856

(51) Int. Cl. G06N 3/08; H01M 10/0525; H01M 4/505; H01M 4/525

(52) U.S. Cl. CPC G06N 3/08; H01M 10/0525; H01M 4/505; H01M 4/525

(57) ABSTRACT

To provide a method for predicting the c-axis length of a lithium compound crystal structure, a method for building a learning model for predicting a c-axis length, and a system for predicting a crystal structure having the maximum c-axis length. A method for predicting the c-axis length of a crystal structure of a lithium compound containing cobalt, nickel, and manganese includes preparing a descriptor including n values (n is an integer greater than or equal to 0) obtained by converting a crystal structure of the lithium compound in which manganese at any one or more of n sites is substituted by a metal atom among crystal structures of the lithium compound into binary data and a characteristic value of the metal atom; inputting the descriptor into a learned learning model; and outputting a predicted value of c-axis length of an optimized crystal structure and a descriptor corresponding to the optimized crystal structure as an output value of the learning model.

### BACKGROUND OF THE INVENTION

### 1. Field of the Invention

The present invention relates to a method for predicting the c-axis length of a lithium compound crystal structure, a method for building a learning model, and a system for predicting a crystal structure having the maximum c-axis length.

### 2. Description of the Related Art

The characteristics of lithium compounds used for electrode materials of lithium-ion secondary batteries had never been known unless the target substance was synthesized and its property was directly measured. Experts can guess approximate values of the physical properties of a lithium compound having a certain crystal structure these days when data are accumulated because the characteristics are determined by the crystal structure of the lithium compound. Prediction can also be made by first-principles calculation in recent years.

In accordance with required characteristics, a lithium compound having the corresponding physical properties is selected and used in research and development involving lithium compounds. Thus, if a lithium compound having required physical properties can be accurately predicted and selected from among known substances and unknown substances to be used without being actually synthesized, the development speed is expected to be significantly increased.

Not everyone can make the accurate prediction described above and the simulation requires considerable amount of cost and time under the present circumstances. However, since there are very many candidate lithium compounds, a method and a system that allow anyone to predict the physical properties of the target lithium compound easily and quickly have been desired.

In recent years, a method of classification, estimation, or prediction employing machine learning has advanced significantly. In particular, selection and prediction by deep learning using a convolutional neural network as a learning method of an artificial intelligence (AI) system have significantly improved in performance, and produced excellent effects in various fields. However, in the field covering lithium compounds, there are as yet almost no sufficient methods for describing lithium compounds that allow, with an adequate information volume, computers to understand the structures of lithium compounds without any discrepancy and to accurately extract features related to physical properties. Thus, a method and a system that allow anyone to predict the physical properties of a lithium compound easily and accurately have not been achieved yet.

Patent Document 1 discloses a method and a system for predicting the physical property of an organic compound using machine learning.

### REFERENCE

[Patent Document 1] PCT International Publication No. WO2019/048965

### SUMMARY OF THE INVENTION

Lithium composite oxides containing nickel (Ni), cobalt (Co), and manganese (Mn) (the lithium composite oxides are called NCM), which are high-capacity materials, have been used for many home-use large secondary batteries or in-vehicle secondary batteries. In a secondary battery using NCM as a positive electrode active material, the volume of active material particles is changed (and the c-axis length of the crystal structure is extended) by insertion and extraction of lithium ions during charge and discharge. Substitution elements of NCM that inhibit a change in the volume of active material particles have been searched for through trial and error.

In the case of employing first-principles calculation for c-axis length calculation in predicting a material that has a small change in volume, the reliability of the calculation result is relatively high; however, the load of the calculation is also high because of the use of a number of parameters. Therefore, data processing devices having processing capability equivalent to that of a normal processor have a problem of taking much time for c-axis length calculation.

In view of the above, an object of one embodiment of the present invention is to provide a method for acquiring information on a c-axis length in a comparatively short time. Another object is to provide a method for predicting the c-axis length of the crystal structure of a reliable lithium compound. Another object is to provide a method for building a learning model for predicting a c-axis length. Another object is to provide a system for predicting a crystal structure having the maximum c-axis length.

Note that the description of these objects does not preclude the existence of other objects. One embodiment of the present invention does not need to achieve all the objects listed above. Other objects can be derived from the description of the specification, the drawings, and the claims.

One embodiment of the present invention is to obtain the c-axis length of a crystal structure of a lithium compound with the use of a learning model using, as training data, a c-axis length obtained by a first-principles calculation unit. The learning model refers to a machine learning model, specifically, a learning model using a machine learning algorithm. Training data is composed of a combination of output data (e.g., a c-axis length) that is ground truth data and input data.

Specifically, one embodiment of the present invention is a method for predicting the c-axis length of a crystal structure of a lithium compound containing cobalt, nickel, and manganese, which includes the following steps: a step of preparing a descriptor including n values (n is an integer greater than or equal to 0) obtained by converting a crystal structure of the lithium compound in which the manganese at any one or more of n sites is substituted by a metal atom among crystal structures of the lithium compound into binary data and a characteristic value of the metal atom; a step of inputting the descriptor into a learned learning model; and a step of outputting a predicted value of c-axis length of an optimized crystal structure and a descriptor corresponding to the optimized crystal structure as an output value of the learning model.

In the above embodiment, the learning model is built using a Gaussian process regression model or a convolutional neural network. For another example, a learning model may be built using a linear support-vector machine (also called linear SVM), Elastic Net, Decision trees, Random forest, or gradient boosting.

In the above embodiment, a calculation model of a lithium compound crystal structure set by a user is a set of 360 elements. The user may appropriately change the number of elements of an element set in a model for calculating a lithium compound crystal structure, with the use of a crystal structure setting unit.

A method for building the above learning model is also one embodiment of the present invention. The method is for building a learning model for predicting the c-axis length of a crystal structure of a lithium compound containing cobalt, nickel, and manganese and includes a step of acquiring, as a descriptor, n values obtained by converting a crystal structure of the lithium compound in which the manganese at any one or more of n sites (n is an integer greater than or equal to 0) is substituted by a metal atom among crystal structures of the lithium compound into binary data; and a step of adding a characteristic value of the metal atom to the descriptor. The c-axis length of a crystal structure in which manganese at one of n sites is substituted by the metal atom is used as part of training data.

In the above embodiment, the c-axis length used as part of the training data of the learning model is a value calculated by Vienna Ab initio Simulation Package (VASP). VASP does not necessarily need to be used, and any optimization program can be used. As a c-axis length to be used as training data, a value disclosed in a known database may be used. A learning model obtained by performing learning with the use of appropriate training data is referred to as a learned learning model. Note that a learned learning model is not a learning model that does not learn any more, and can further learn.

In the above embodiment, a descriptor having an absolute value of contribution to learning of greater than or equal to 0.001 is extracted among characteristic values of the metal atom, with the use of a regression model.

In the above embodiment, the characteristic value of the metal atom is the ionic radius, the first ionization energy, the atomic volume, the atomic radius, or the valence.

In the above embodiment, the lithium compound is set as a material that can be represented as LiₓNi_{0.89}Co_{0.05}Mn_{y}M_{z} (M is a substitution element). The substitution element M is not limited to a single metal atom and may be two or more metal atoms. For example, M which is two different kinds of metal atoms is represented as LiₓNi_{0.89}Co_{0.05}Mn_{y}M1_{z1}M2_{z2}. Although in the above embodiment, a learning model is built on the assumption of an NCM crystal structure, for example, one embodiment of the present invention is not particularly limited thereto. Even a learning model for a lithium compound such as a material called LCO or a material called lithium iron phosphate can be built by making the learning model learn the corresponding crystal structure.

In the above embodiment, a metal atom serving as the substitution element M is a transition metal atom, and is any one or more of Group 3 to Group 11 elements, specifically, Mg, Al, Sc, Ti, V, Cr, Fe, Cu, Zn, Ga, and Ge.

Part or all of the above learned learning model may be stored in a storage device of a memory, a hard disk drive, or a solid state drive (SSD) to build a system for predicting a crystal structure having the maximum c-axis length, which includes at least the storage device.

One embodiment of the present invention is a system for predicting a crystal structure, which includes a crystal structure setting unit that determines a crystal structure containing lithium, cobalt, nickel, and manganese; a descriptor generating unit that generates a descriptor including the kind of a metal atom and information on the site of a substitution element in a crystal structure in which manganese at m sites (m is an integer greater than or equal to 0) is substituted by the metal atom; a first-principles calculation unit that calculates the c-axis length of a crystal structure in which the substitution element is positioned, by first-principles calculation; and a learning unit that performs learning using a first-principles calculation result as training data. In the system, a learning result obtained by the learning unit includes a maximum c-axis length.

Part or all of the above learned learning model may be designed by an integrated circuit (IC) and implemented with the use of hardware provided with the IC, and an apparatus for predicting a crystal structure, which is capable of being controlled by a user, may be fabricated by being combined with a display device. The prediction apparatus can also be referred to as a solution search processing device because the user inputs an object or a problem to it so that a solution is output.

According to one embodiment of the present invention, when reliable information on a c-axis length obtained by first-principles calculation is learned by machine learning, first-principles calculation with a large load does not need to be performed on the cases where substitution is performed for all substitution elements and all possible combinations of substitution sites of a crystal structure, and performing first-principles calculation only for part of the possible combinations of substitution sites enables acquisition of reliable information on a c-axis length and a crystal structure corresponding to the c-axis length in a comparatively short time.

Note that the description of these effects does not preclude the existence of other effects. One embodiment of the present invention does not need to have all the effects listed above. Other effects can be derived from the description of the specification, the drawings, and the claims.

### BRIEF DESCRIPTION OF THE DRAWINGS

In the accompanying drawings:

FIG. 1 illustrates a method for predicting a c-axis length of one embodiment of the present invention;

FIGS. 2A to 2C each illustrate a crystal structure and its corresponding descriptor of one embodiment of the present invention;

FIGS. 3A to 3D each illustrate a crystal structure and its corresponding descriptor of one embodiment of the present invention;

FIG. 4 illustrates a method for building a learning model of one embodiment of the present invention;

FIG. 5 illustrates a calculation model of an NCM crystal structure of one embodiment of the present invention;

FIG. 6 is a graph showing the relation between a c-axis length and a lithium concentration;

FIG. 7 is a flowchart showing a method for searching for a crystal structure of one embodiment of the present invention;

FIG. 8 is a flowchart showing a method for searching for a crystal structure of one embodiment of the present invention;

FIG. 9 is a flowchart showing a method for searching for a crystal structure of one embodiment of the present invention;

FIGS. 10A to 10C show a method for searching for a crystal structure of one embodiment of the present invention;

FIGS. 11A and 11B show the method for searching for a crystal structure of one embodiment of the present invention;

FIG. 12 illustrates a structure of a solution search processing device of one embodiment of the present invention;

FIGS. 13A and 13B illustrate a structure example of neural network processing of one embodiment of the present invention;

FIG. 14 is a graph showing results of comparison between a predicted c-axis length and a c-axis length that is ground truth data;

FIG. 15 is a graph showing contribution to learning;

FIGS. 16A and 16B show the method for searching for a crystal structure of one embodiment of the present invention; and

FIG. 17 shows a crystal structure calculation model representing a search result.

### DETAILED DESCRIPTION OF THE INVENTION

Hereinafter, embodiments of the present invention will be described in detail with reference to the drawings. Note that the present invention is not limited to the description below, and it is easily understood by those skilled in the art that modes and details of the present invention can be modified in various ways. In addition, the present invention should not be construed as being limited to the description in the following embodiments.

### Embodiment 1

When the volume of a positive electrode active material of a secondary battery is expanded or contracted owing to movement of lithium ions by charge and discharge, cracks are made; accordingly, the positive electrode active material deteriorates and thus the reliability of the secondary battery decreases. Therefore, a material that has a small change or almost no change in volume in charge and discharge is ideally desired. In other words, a material to and from which lithium ions can be inserted and extracted with almost no change in crystal structure is desired. With a focus on a c-axis length in the present invention, it is an object to devise a method for discovering a crystal structure that has a small change in the c-axis length between before and after expansion or contraction due to movement of lithium ions. Thus, first, a large c-axis length is predicted.

In this embodiment, an NCM crystal structure is used as a basic crystal structure, and the c-axis length of a material having an unknown crystal structure is predicted. Searching for a characteristic parameter of a novel material on the basis of statistical learning utilizing data obtained by experiments or theoretical calculations is called materials informatics (MI). Thus, a method for predicting the c-axis length of a material having an unknown crystal structure, which will be described below in this embodiment, is a type of MI.

To search for a material that has a small change in volume between before and after expansion or contraction due to movement of lithium ions, a crystal structure is fixed to a layered rock salt structure and the c-axis length of a material in which manganese positioned in the crystal structure is substituted is predicted.

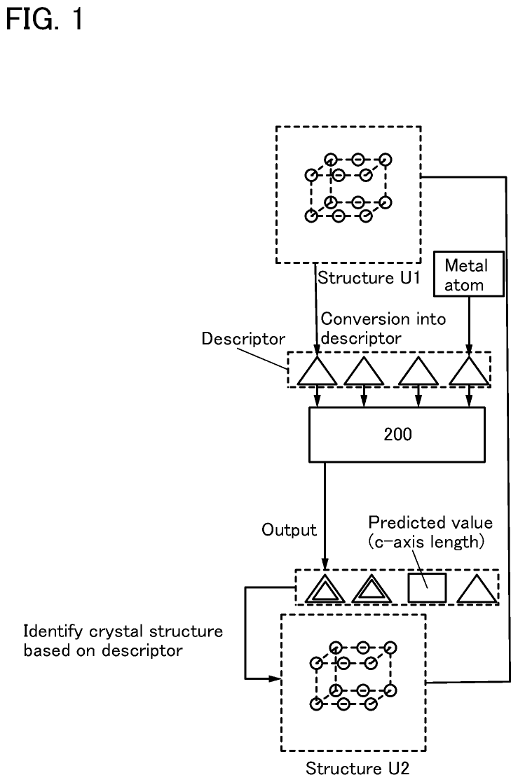

FIG. 1 is a diagram for explaining prediction of the c-axis length of a material having an unknown crystal structure.

FIG. 1 is a conceptual diagram illustrating a process in which a structure U1 is converted into a descriptor, the characteristic values of a metal atom are also used as descriptors, and the descriptors are input to a learned learning model 200, so that an output including a predicted value, specifically, a c-axis length in this embodiment is obtained.

First, the structure U1 that is a layered rock-salt structure is converted into a descriptor. The descriptor can also be referred to as an identifier or a parameter that affects a solution to be obtained when being input to the learning model. The structure U1 is a layered rock-salt crystal structure and is set to a crystal structure including n manganese atoms (n is an integer greater than or equal to 0). Here, a crystal structure refers to the size and structure of a calculation model determined by a user, and one crystal structure is regarded as one crystal. In this embodiment, the c-axis length of a structure in which one of six manganese atoms is substituted by a substitution element is predicted.

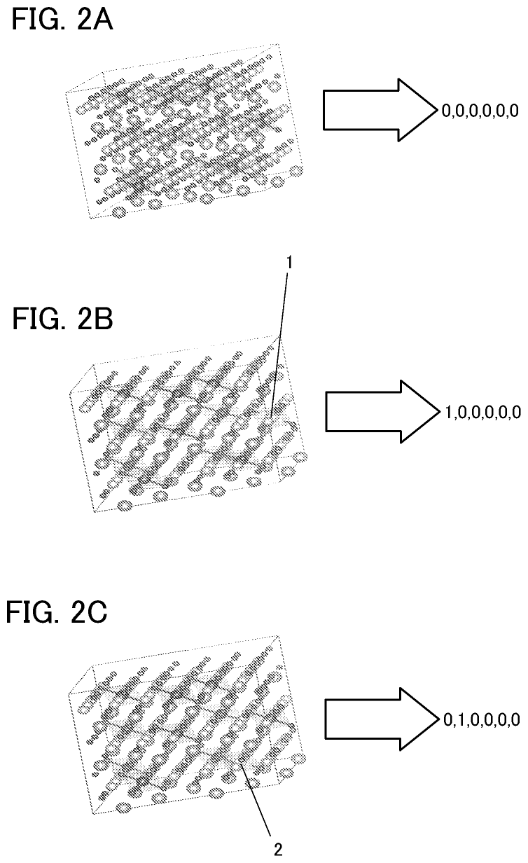

Arrangement sites of six manganese atoms are converted into binary data, and a descriptor composed of the binary data is prepared. The binary data are “0” and “1”. For example, a crystal structure including six manganese atoms is converted into (0, 0, 0, 0, 0, 0). In other words, the crystal structure including six manganese atoms is encoded. FIG. 2A shows the crystal structure and its corresponding descriptor. The descriptor (0, 0, 0, 0, 0, 0) is only a row of values by which part of the crystal structure is replaced, and descriptors are further added so as to be associated with the kinds of atoms at arrangement sites. Note that the structure U1 itself including six manganese atoms is not used for the learning model. For the learning model, the structure U1 in which at least one site of six manganese atoms is substituted is used.

For example, the crystal structure when manganese at the first site is substituted by a substitution element is converted into (1, 0, 0, 0, 0, 0). FIG. 2B shows the crystal structure and its corresponding descriptor. As a site at which manganese is substituted, “1” of the binary data is written.

The crystal structure when manganese at the second site is substituted by a substitution element is converted into (0, 1, 0, 0, 0, 0). FIG. 2C shows the crystal structure and its corresponding descriptor.

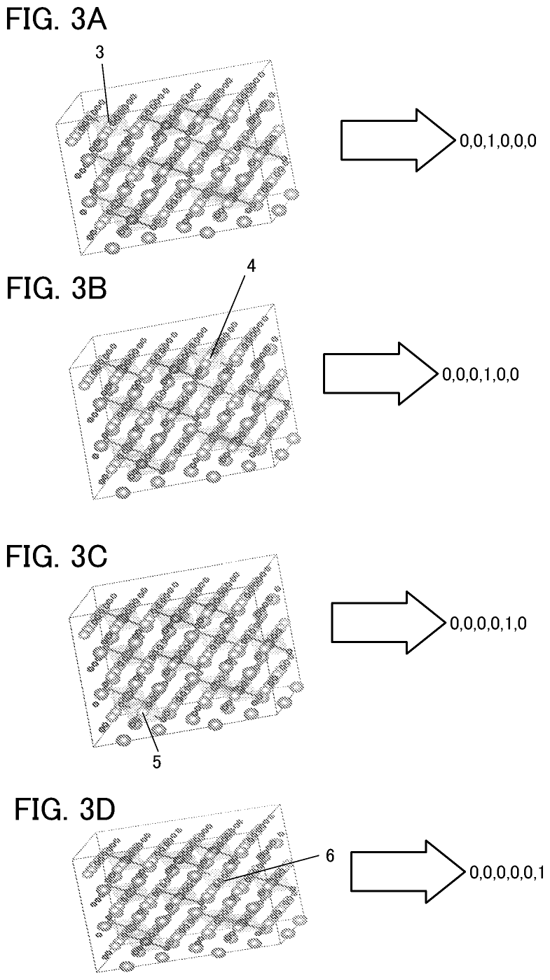

The crystal structure when manganese at the third site is substituted by a substitution element is converted into (0, 0, 1, 0, 0, 0). FIG. 3A shows the crystal structure and its corresponding descriptor.

The crystal structure when manganese at the fourth site is substituted by a substitution element is converted into (0, 0, 0, 1, 0, 0). FIG. 3B shows the crystal structure and its corresponding descriptor.

The crystal structure when manganese at the fifth site is substituted by a substitution element is converted into (0, 0, 0, 0, 1, 0). FIG. 3C shows the crystal structure and its corresponding descriptor.

The crystal structure when manganese at the sixth site is substituted by a substitution element is converted into (0, 0, 0, 0, 0, 1). FIG. 3D shows the crystal structure and its corresponding descriptor.

In addition, the characteristic values of metal atoms as substitution elements are also converted into descriptors. Transition metal atoms are selected as the metal atoms, and the valences, the first ionization energies, the atomic radii, or the ionic radii are set as their characteristic values. For example, in the case where manganese at the first site is substituted by titanium, the descriptors thereof are expressed as (1, 0, 0, 0, 0, 0, 4, 6.82812, 147, 0.605). The characteristic values of the metal atoms are arranged as they are in the descriptors. Table 1 shows an example of descriptors arranged according to the substitution site and the plurality of characteristic values as labels. The row shown in Table 1 corresponds to the descriptors. Substitution site, valence, first ionization energy, atomic radius, and ionic radius in Table 1 are a character string of labels shown as supplementary information for easy understanding.

TABLE 1

| | | | | | | | First | | |
|---|---|---|---|---|---|---|---|---|---|
| Substitution site | | | | | | | ionization | Atomic | Ionic |
| 1 | 2 | 3 | 4 | 5 | 6 | Valence | energy | radius | radius |
| 1 | 0 | 0 | 0 | 0 | 0 | 4 | 6.82812 | 147 | 0.605 |

The descriptors in a row in which information on the substitution site and the characteristic values are arranged as described above can also be referred to as a data set corresponding to a relevant information string.

These descriptors are input to the learned learning model 200 and calculation is performed, whereby a predicted c-axis length is output as a calculation result. In the learning model, descriptors corresponding to the predicted c-axis length are also output together with the predicted c-axis length. For example, in the case where a descriptor (1, 0, 0, 0, 0, 0, a c-axis length, 4, 6.82812, 147, 0.605) is output, it can be read that the first to sixth values from the left indicate the c-axis length of a structure in which manganese at the first site is substituted by a substitution element and the seventh to last values indicate that the substitution element is titanium.

TABLE 2

| | | | | | | | | First | | |
|---|---|---|---|---|---|---|---|---|---|---|
| Substitution site | | | | | | C-axis | | ionization | Atomic | Ionic |
| 1 | 2 | 3 | 4 | 5 | 6 | length | Valence | energy | radius | radius |
| 1 | 0 | 0 | 0 | 0 | 0 | 14.021 | 4 | 6.82812 | 147 | 0.605 |

The crystal structure of a structure U2 corresponding to the value of a c-axis length output as shown in Table 2 can be identified, that is, which manganese atom of the six manganese atoms of the crystal structure is substituted by which metal atom and the c-axis length of the crystal structure can be determined. The structure U2 is a structure after optimization of the structure U1.

A learning model is a machine learning model and is a method for analyzing data. A learning model can be regarded as a program for performing calculation allowing ground truth data to be led from given parameter data. A program is architected in a prescribed format using a programming language. Examples of programming languages include C, Java, and Python. A programmer selects one of these programming languages and creates a source code in the prescribed format. A source code means a statement for executing a program and contents about what processing the program is to perform are composed in a text file. A source code refers to a set of commands, a set of spaces, or a set of values used when a processor composes a statement for calculation, and the program arranges a plurality of source codes composed of commands, spaces, or values, according to a predetermined rule or in a predetermined order. A variable for inputting a source code and a setting value for determination are written in the program in advance. As a program becomes complicated, the number of source codes increases; thus, a program is created with groups of source codes classified into source files according to functions or processing screens so that a programmer can easily check or read the source codes. A learning model is an open source, and source codes of the program are publicly available. In general, in the case where a predicted value is output using a learning model, training data is obtained by connecting one ground truth to an input value; thus, only the predicted value is output though a process in the learning model is unclear. For example, a predicted value can be obtained by inputting various values to a learning model; however, it has been difficult to determine through what process the predicted value is obtained. Specifically, the maximum value of c-axis length to be output can be predicted with a learning model; however, it has been difficult to determine what crystal structure corresponds to the value.

In this embodiment, the original structure U1 is determined and the structure U2 in which one atom or some atoms of the crystal structure are substituted by a substitution element is assumed. The information on a portion of a structure that is not changed is not input to the learning model, and the information on only a portion that is changed is input as a descriptor to the learning model. Then, by output of one row of data connecting the descriptor and a predicted value (c-axis length) to be output, the predicted value (c-axis length) can be obtained.

Furthermore, from the descriptor corresponding to the predicted value (c-axis length), a crystal structure (structure U2) can be identified. For example, in the case where a descriptor (0, 0, 0, 0, 1, 0, a c-axis length, 4, 6.82812, 147, 0.605) is output as shown in Table 3, the c-axis of a layered rock-salt crystal structure in which manganese at the fifth site is substituted by titanium is obtained.

TABLE 3

| | | | | | | | | First | | |
|---|---|---|---|---|---|---|---|---|---|---|
| Substitution site | | | | | | C-axis | | ionization | Atomic | Ionic |
| 1 | 2 | 3 | 4 | 5 | 6 | length | Valence | energy | radius | radius |
| 0 | 0 | 0 | 0 | 1 | 0 | 14.019 | 4 | 6.82812 | 147 | 0.605 |

In this embodiment, in the case where a substitution element of the structure U2 is a transition metal element, assuming that the number of substitution sites is only one, the number of kinds of transition metal elements×6 kinds of structures are conceivable. When structures in each of which substitution elements of one kind are positioned at two or more sites and structures in each of which substitution elements of different kinds are positioned at two or more sites are taken into consideration, a number of combinations are conceivable.

Even when the number of combinations is enormous, descriptors are arranged in the lateral direction on paper as one row of data and other descriptors are arranged in the vertical direction, whereby data can be arranged like a determinant. The rows and columns can be input to the learning model and output in a matrix manner. Accordingly, even when the amount of data is huge, output display described in this embodiment, specifically, a structure in which descriptors and a c-axis length are together in a row has an advantage that a user can easily identify a crystal structure on the basis of the corresponding data.

### Embodiment 2

Although the example of using a learned learning model as a learning means is described in Embodiment 1, a method for building the learned learning model will be described below in this embodiment.

In this embodiment, training data of the learning model is prepared using first-principles calculation. In this embodiment, as first-principles calculation software, Vienna Ab initio Simulation Package (VASP) is used.

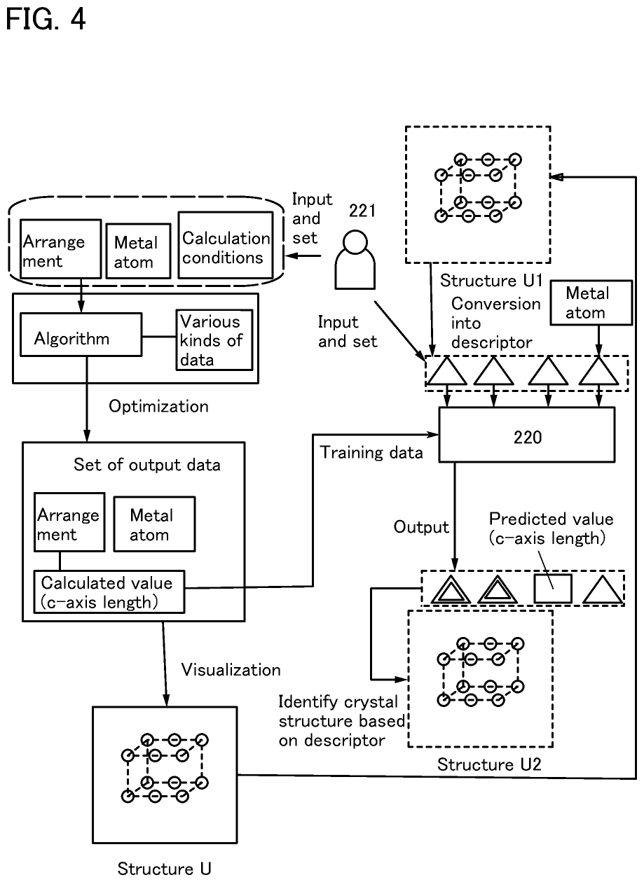

FIG. 4 illustrates a method for building a learning model 220.

First, the first-principles calculation software VASP will be described.

VASP is a program for structure optimization. With conditions set on the basis of the data on the pristine structure, atomic sites and the size of a calculation model are optimized, and eventually, the data on an optimized three-dimensional structure can be acquired.

In the case of using VASP, first, the crystallographic information file (CIF) is obtained from ICSD. The data on the sites of non-metal atoms or metal atoms, such as lithium, nickel, cobalt, and manganese, are set in POSCAR (a file of the pristine structure), and the pseudopotentials of the atoms are set in POTCAR (a file of potentials). A user 221 selects the size of a calculation model (360 atoms in this embodiment). The unit of the size of a calculation model is regarded as one crystal, and calculation is performed. Although the size of the calculation model is set to 360 in this embodiment, it is not particularly limited thereto; the user 221 can determine it appropriately.

In addition, parameters for determining under what conditions first-principles calculation is performed are input to INCAR (an input file). Time taken for arithmetic processing depends on KPOINTS that determines the mesh width of a reciprocal lattice space. KPOINTS is set appropriately by the user 221. When the calculation is executed using the setting files, the pristine structure is optimized and the optimized structure and the c-axis length are output as a result to CONTCAR. Note that all output results of energy and magnetic moments are output to OUTCAR.

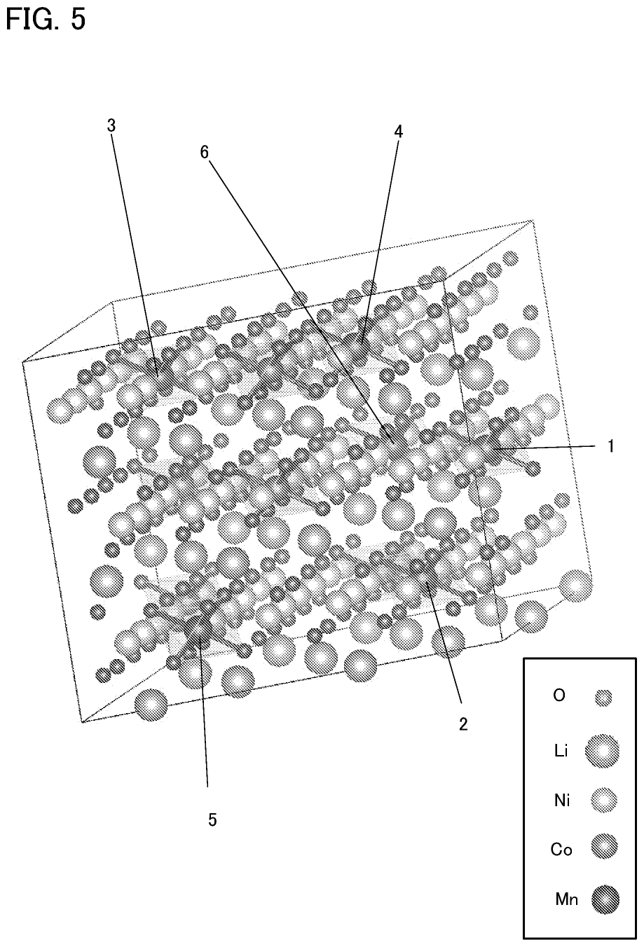

FIG. 5 shows a calculation model of a crystal structure obtained by changing an NCM crystal structure set by the user 221 (36 Li atoms, 97 Ni atoms, 5 Co atoms, 6 Mn atoms, and 216 oxygen atoms; 360 atoms in total) by Visualization for Electronic and STructural Analysis (VESTA) on the basis of the data in the CONTCAR file of VASP, for easy visualization. FIG. 5 shows a calculation model of the crystal structure after the structure optimization. The calculation model of the crystal structure in FIG. 5 corresponds to a structure U in FIG. 4. FIG. 4 is a schematic diagram of the model of the crystal structure obtained by partly simplifying FIG. 5, and one embodiment is not particularly limited thereto.

The crystal structure in FIG. 5 is the same as that in FIG. 2A except for the scale ratio.

Here, a method for determining the number of lithium atoms in the NCM crystal structure will be described below.

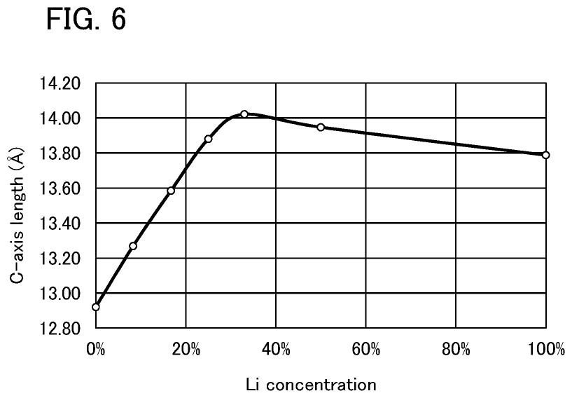

The relation between a c-axis length and a lithium concentration is examined using a crystal structure in which manganese at the first site is substituted by aluminum. FIG. 6 shows calculation results under seven different conditions of lithium concentration.

In FIG. 6, the vertical axis represents a calculated c-axis length and the horizontal axis represents a lithium concentration as a theoretical value.

As shown in FIG. 6, the c-axis length is the longest when the lithium concentration is 33.3 atomic %. In general, in order to make the lithium concentration within the range where a secondary battery is safely used, a secondary battery designer sets it such that a protective circuit stops power supply when the lithium concentration becomes out of the range of lithium concentration where the secondary battery is safely used. Thus, a crystal structure where the lithium concentration is zero, which is a condition shown in FIG. 6, is not used. The safe range of lithium concentration generally set by a secondary battery designer is practically considered to be the range where the lower limit of lithium concentration is approximately 20 atomic %. In view of the above, the present inventors set a crystal structure composed of 360 atoms in total, specifically, 36 Li atoms, 97 Ni atoms, 5 Co atoms, 6 Mn atoms, and 216 oxygen atoms with the upper limit of lithium concentration being approximately 33.3 atomic %, at which the c-axis length is the longest.

In the above manner, the user 221 inputs and sets the arrangement of atoms, the information on the parameters of non-metal atoms or metal atoms, and calculation conditions. Depending on the setting of these values and conditions, an error occurs and as a result, calculation results cannot be obtained in some cases. Thus, the user 221 sets these values and conditions through repeated trial and error. The trial and error require a huge amount of time.

The first-principles calculation software contains an algorithm and various kinds of data that cannot be known by the user 221; thus, through what process output data is acquired is unclear.

In the case where the user 221 can input and set parameters and calculation conditions well, a set of output data on the optimized crystal structure can be acquired. The set of output data contains the set arrangement of atoms and a number of various characteristic values associated with metal atoms. One of the characteristic values is a c-axis length. The c-axis length is used as one piece of training data of the learning model 220.

Next, a method for building the learning model 220 will be described.

The user 221 specifies an element that is likely to be substituted in the structure U after structure optimization obtained by the first-principles calculation software, and assumes that the number of sites at which the element is substituted, that is, substitution sites is n.

Next, the structure U1 with n substitution sites is assumed on the basis of the structure U. Note that the structure U and the structure U1 are both a layered rock-salt crystal structure.

Then, the structure U1 is converted into a descriptor. The details are described in Embodiment 1. The characteristic values of a metal atom are also made to be one row of data. As the characteristic values of the metal atom, the values of a known database are used.

To create first training data, the user 221 performs first-principles calculation on a structure where Mn in the first substitution site in the structure U1 is substituted by Mg. Then, one row of data (1, 0, 0, 0, 0, 0, Mg, a c-axis length), in which the obtained c-axis length is additionally placed, is obtained as the first training data. Although Mg is written here for simplicity, a plurality of characteristic values of Mg are actually arranged. The calculation result of the c-axis length is 14.015. Table 4 shows labels, the row of descriptors, Mg, and the value of c-axis length.

TABLE 4

| Substitution site | | | | | | Substitution | C-axis |
|---|---|---|---|---|---|---|---|
| 1 | 2 | 3 | 4 | 5 | 6 | element | length |
| 1 | 0 | 0 | 0 | 0 | 0 | Mg | 14.015 |

To create second training data, the user 221 performs first-principles calculation on a structure where Mn in the second substitution site in the structure U1 is substituted by Mg. Then, one row of data (0, 1, 0, 0, 0, 0, Mg, a c-axis length), in which the obtained c-axis length is additionally placed, is obtained as the second training data. The calculation result of the c-axis length is 14.025. Table 5 shows labels, the row of descriptors, Mg, and the value of c-axis length.

TABLE 5

| Substitution site | | | | | | Substitution | C-axis |
|---|---|---|---|---|---|---|---|
| 1 | 2 | 3 | 4 | 5 | 6 | element | length |
| 0 | 1 | 0 | 0 | 0 | 0 | Mg | 14.025 |

To create third training data, the user 221 performs first-principles calculation on a structure where Mn in the third substitution site in the structure U1 is substituted by Mg. Then, one row of data (0, 0, 1, 0, 0, 0, Mg, a c-axis length), in which the obtained c-axis length is additionally placed, is obtained as the third training data. The calculation result of the c-axis length is 14.023. Table 6 shows labels, the row of descriptors, Mg, and the value of c-axis length.

TABLE 6

| Substitution site | | | | | | Substitution | C-axis |
|---|---|---|---|---|---|---|---|
| 1 | 2 | 3 | 4 | 5 | 6 | element | length |
| 0 | 0 | 1 | 0 | 0 | 0 | Mg | 14.023 |

To create fourth training data, the user 221 performs first-principles calculation on a structure where Mn in the fourth substitution site in the structure U1 is substituted by Mg. Then, one row of data (0, 0, 0, 1, 0, 0, Mg, a c-axis length), in which the obtained c-axis length is additionally placed, is obtained as the fourth training data. The calculation result of the c-axis length is 14.015. Table 7 shows labels, the row of descriptors, Mg, and the value of c-axis length.

TABLE 7

| Substitution site | | | | | | Substitution | C-axis |
|---|---|---|---|---|---|---|---|
| 1 | 2 | 3 | 4 | 5 | 6 | element | length |
| 0 | 0 | 0 | 1 | 0 | 0 | Mg | 14.015 |

To create fifth training data, the user 221 performs first-principles calculation on a structure where Mn in the fifth substitution site in the structure U1 is substituted by Mg. Then, one row of data (0, 0, 0, 0, 1, 0, Mg, a c-axis length), in which the obtained c-axis length is additionally placed, is obtained as the fifth training data. The calculation result of the c-axis length is 14.014. Table 8 shows labels, the row of descriptors, Mg, and the value of c-axis length.

TABLE 8

| Substitution site | | | | | | Substitution | C-axis |
|---|---|---|---|---|---|---|---|
| 1 | 2 | 3 | 4 | 5 | 6 | element | length |
| 0 | 0 | 0 | 0 | 1 | 0 | Mg | 14.014 |

To create sixth training data, the user 221 performs first-principles calculation on a structure where Mn in the sixth substitution site in the structure U1 is substituted by Mg. Then, one row of data (0, 0, 0, 0, 0, 1, Mg, a c-axis length), in which the obtained c-axis length is additionally placed, is obtained as the sixth training data. The calculation result of the c-axis length is 14.016. Table 9 shows labels, the row of descriptors, Mg, and the value of c-axis length.

TABLE 9

| Substitution site | | | | | | Substitution | C-axis |
|---|---|---|---|---|---|---|---|
| 1 | 2 | 3 | 4 | 5 | 6 | element | length |
| 0 | 0 | 0 | 0 | 0 | 1 | Mg | 14.016 |

Through the above-described process, the learning model 220 can be made to learn the data on the c-axis length of a basic crystal structure and the data on the c-axis lengths of six kinds of crystal structures with Mg as a substitution element.

The user 221 performs first-principles calculation on a structure where Mn in each of the first substitution site and the second substitution site in the structure U1 is substituted by Mg. Then, the learning model 220 is made to learn one row of data (1, 1, 0, 0, 0, 0, Mg, a c-axis length), in which the obtained c-axis length is additionally placed. In the case where the number of substitution sites is two, the data on the c-axis lengths of 15 kinds of crystal structures can be used as part of training data. The calculation result of the c-axis length is 14.027. Table 10 shows labels, the row of descriptors, Mg, and the value of c-axis length.

TABLE 10

| Substitution site | | | | | | Substitution | C-axis |
|---|---|---|---|---|---|---|---|
| 1 | 2 | 3 | 4 | 5 | 6 | element | length |
| 1 | 1 | 0 | 0 | 0 | 0 | Mg | 14.027 |

In addition, the user 221 performs first-principles calculation on a structure where Mn in each of the first substitution site, the second substitution site, and the third substitution site in the structure U1 is substituted by Mg. Then, the learning model 220 is made to learn one row of data (1, 1, 1, 0, 0, 0, Mg, a c-axis length), in which the obtained c-axis length is additionally placed. In the case where the number of substitution sites is three, the data on the c-axis lengths of 20 kinds of crystal structures can be used as part of training data. It is needless to say that the number of substitution sites may be four, five, or six. The calculation result of the c-axis length is 14.028. Table 11 shows labels, the row of descriptors, Mg, and the value of c-axis length.

TABLE 11

| Substitution site | | | | | | Substitution | C-axis |
|---|---|---|---|---|---|---|---|
| 1 | 2 | 3 | 4 | 5 | 6 | element | length |
| 1 | 1 | 1 | 0 | 0 | 0 | Mg | 14.028 |

In order to enrich training data, the user 221 calculates c-axis lengths by first-principles calculation under different conditions of substitution metal atoms. For example, in the case where a substitution metal atom is Al, even considering one substitution site, two substitution sites, and three substitution sites needs calculation of 41 kinds of c-axis length data. Examples of other substitution elements include transition metal elements such as Sc, Ti, V, Cr, Fe, Cu, Zn, Ga, and Ge.

Although the number of kinds of metal atoms described above is only one, when the case where different metal atoms are positioned at two or more substitution sites is taken into consideration, a larger amount of c-axis length data can be acquired.

The values of a known database are used as the characteristic values of metal atoms, and it is preferable that characteristic values unrelated to a c-axis length not be employed as descriptors. Thus, contribution is calculated using a regression model, and descriptors when the absolute value of contribution is greater than or equal to 0.001 are extracted.

The above-described c-axis length data are input as ground truth to the regression model, and the contribution of each characteristic value is obtained.

The learning model 220 is built using, as training data, the c-axis length data and descriptors obtained by the above method, whereby the learned learning model described in Embodiment 1 can be built.

Although the user 221 is illustrated in this embodiment, a program may perform setting and inputting, instead of the user 221. For example, when the user converts a substitution site of a crystal structure, the substitution site of the crystal structure may be converted into a descriptor by a program.

### Embodiment 3

In this embodiment, a mode of a method for searching for a crystal structure will be described with reference to drawings.

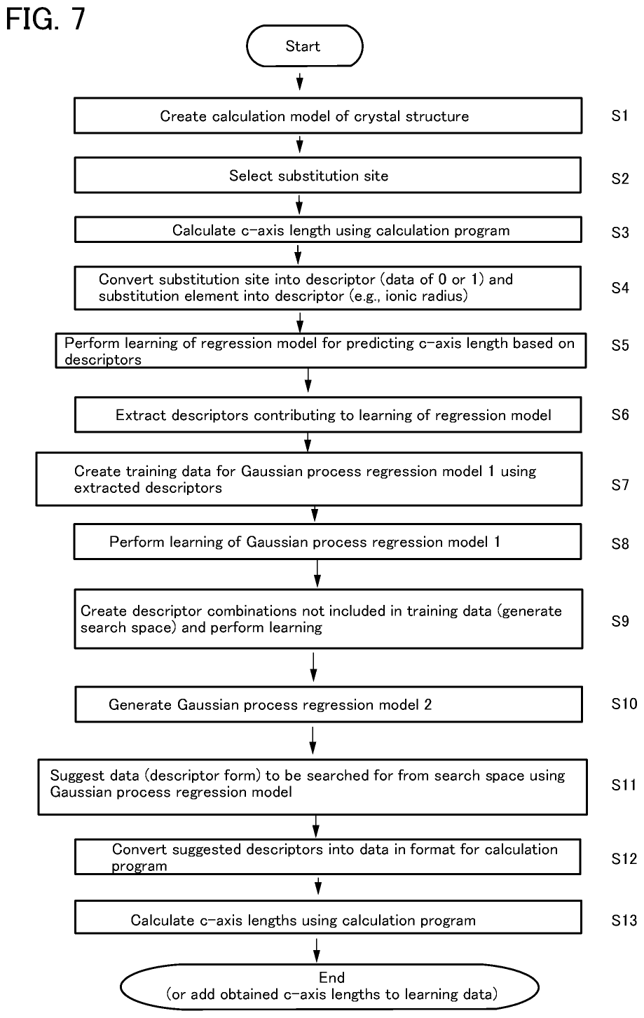

FIG. 7 is a flowchart showing an example of a method for searching for a crystal structure. The flowchart shown in FIG. 7 includes Steps S1 to S13.

First, a user virtually sets a set of unit lattices with a predetermined size, and creates a calculation model of a crystal structure in which a substitution element is positioned at a specific site (substitution site) of the set of unit lattices. In this embodiment, the calculation model of the NCM crystal structure shown in FIG. 5 is created in Step S1.

In Step S2, a site at which Mn of the calculation model of the crystal structure is to be substituted by a substitution element is selected. Substitution sites 1, 2, 3, 4, 5, and 6 in FIG. 5 are examples of the substitution sites. One or more substitution sites are selected from among the substitution sites.

In Step S3, the user calculates the c-axis length when Mn at the substitution site selected in the previous step is substituted by the substitution element. For example, a first-principles electronic state calculation package VASP can be used for the calculation in Step S3.

VASP is a program for structure optimization. With conditions set on the basis of the data on the pristine structure, atomic sites and the size of a calculation model are optimized, and eventually, the data on an optimized three-dimensional structure can be acquired.

In the case of using VASP, first, the crystallographic information file (CIF) is obtained from ICSD. The data on the sites of, for example, lithium, nickel, cobalt, and manganese are set in POSCAR (a file of the pristine structure), and the pseudopotentials of the atoms are set in POTCAR (a file of potentials). The user selects the size of a calculation model (360 atoms in this embodiment). Although the size of the calculation model is set to 360 in this embodiment, it is not particularly limited thereto; the user can determine it appropriately.

In addition, parameters for determining under what conditions first-principles calculation is performed are input to INCAR (an input file). Time taken for arithmetic processing depends on KPOINTS that determines the mesh width of a reciprocal lattice space. KPOINTS is set appropriately by the user. When the calculation is executed using the setting files, the pristine structure is optimized and the optimized structure and the c-axis length are output as a result to CONTCAR. Note that all output results of energy and magnetic moments are output to OUTCAR.

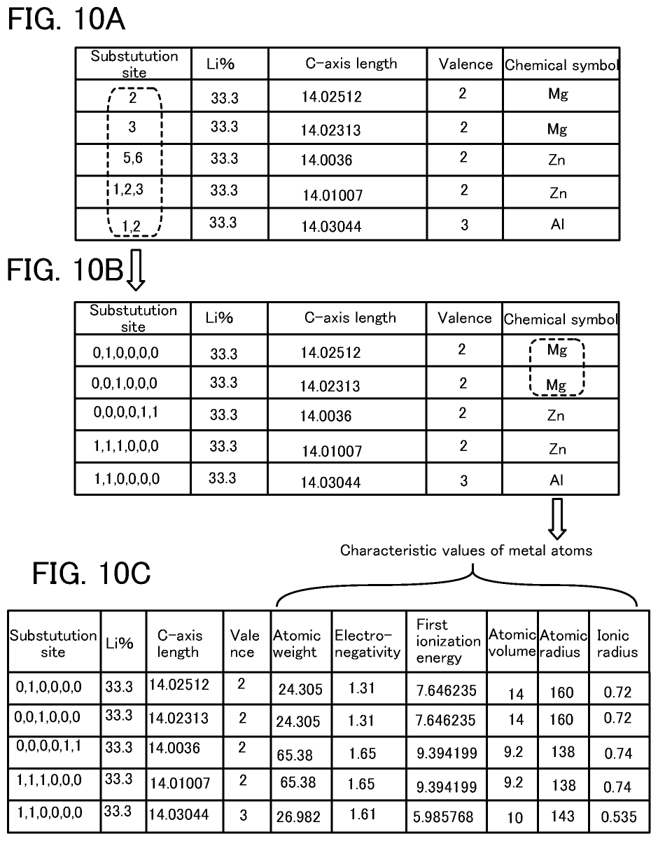

In Step S4, metal atoms substituted for Mn and substitution sites are converted into descriptors expressing them. FIG. 10A shows data before conversion into descriptors, and FIG. 10B shows data after the conversion. Substitution sites are expressed by binary data, using “0” representing being not substituted or “1” representing being substituted.

It is difficult to use chemical symbols representing metal atoms for arithmetic processing; thus, they are converted into characteristic values (parameters). Specifically, a metal atom substituted for manganese is converted into a parameter (e.g., an ionic radius) characterizing the metal atom. FIG. 10C shows data after the conversion. In FIG. 10C, values are all descriptors, and such descriptors can be regarded as intermediate information for learning and calculation.

In Step S5, the descriptors obtained in the previous step and the c-axis length data acquired using a calculation program in Step S3 are associated with each other and input as learning data to a regression model, and learning of the regression model is performed so that a c-axis length can be predicted from the descriptors. As the regression model, LASSO, which is a typical method for sparse modeling, is preferably used. There is no particular limitation on a regression model as long as it is for sparse modeling, and a regression model other than LASSO can be used.

Various factors of the characteristic values of an actual material are deeply involved with each other. Effects given by a variety of large and small factors cause variations in data. When the amount of data is small, the variations in data make it more difficult to obtain a real solution, causing overtraining. LASSO allows extraction of the relation between data, that is, descriptors having zero contribution.

In general, in machine learning, whether the amount of training data is too large or too small, a value expected to be obtained cannot be obtained in some cases. The use of LASSO enables identification of descriptors having zero contribution, reducing the number of descriptors; this is also advantageous to a subsequent Gaussian process regression model. In a Gaussian process regression model, a larger number of variables, that is, a larger number of descriptors require longer time for calculation. In addition, it might be difficult to obtain a high-accuracy predicted value. For example, when all parameters used in VASP are descriptors, it is difficult to obtain a favorable result simply with a Gaussian process regression model.

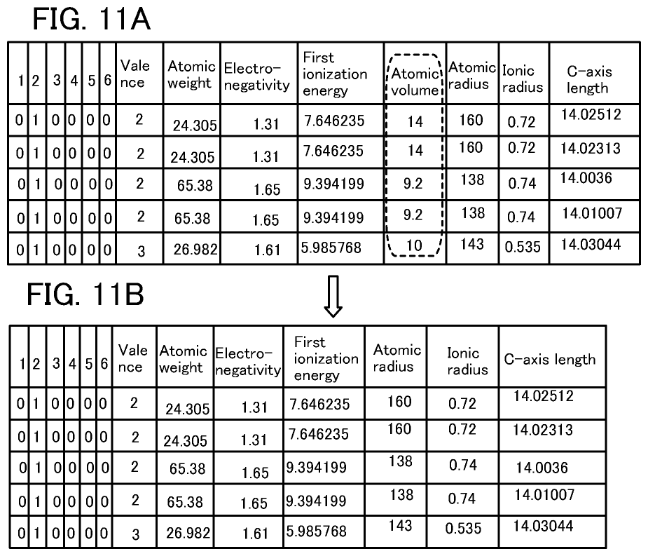

In Step S6, the learning result of the regression model and descriptors contributing to the learning are determined. C-axis lengths predicted from descriptors are compared with the c-axis length of the ground truth data obtained by the calculation in Step S3, and descriptors contributing to the learning with a certain accuracy or above are extracted. FIG. 11A shows descriptors before the extraction, and FIG. 11B shows descriptors after the extraction.

In Step S7, training data for a Gaussian process regression model 1 is created using the descriptors extracted in the previous step. In the case where another learning model is used instead of a Gaussian process regression model, the amount of training data increases, and when the maximum value and the minimum value become fixed, a predicted value within the range between the maximum value and the minimum value might be led with any input value. In such a learning model, even when characteristic values regarding an unknown material are input, predicted values converge. Such a phenomenon is called overtraining. However, when a Gaussian process regression model is used, a variance and a mean are output and predicted values do not converge, resulting in a wide range of predicted values. Accordingly, new possibilities can be discovered.

In Step S8, learning of the Gaussian process regression model 1 is performed on the basis of the training data for the Gaussian process regression model 1, which are created in the previous step.

In Step S9, the user creates combinations of descriptors other than the training data in the previous step, and learning is performed. A search space of the Gaussian process regression model 1 is generated on the basis of new learned contents. Generating a search space means increasing the number of setting conditions; the number of new descriptor combinations other than the descriptor combinations of the training data is increased to add new training data, leading to obtainment of new predicted values.

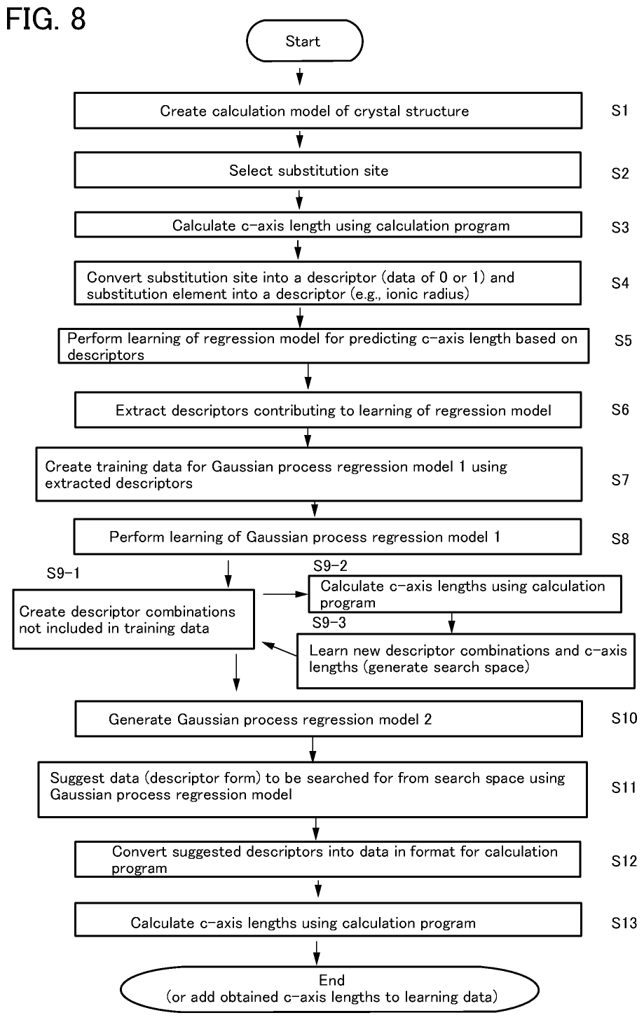

As shown in the flowchart in FIG. 8, Steps S9-1 to S9-3 may be performed instead of Step S9.

In Step S9-1, descriptor combinations other than the descriptor combinations of the training data in the previous step are created.

In Step S9-2, the c-axis lengths of part of the descriptor combinations created in Step S9-1 are calculated by a calculation program typified by VASP to create new training data.

In Step S9-3, learning is performed using, as training data, the descriptor combinations created in Step S9-1 and the c-axis lengths calculated in Step S9-2, and a search space of the Gaussian process regression model 1 is generated on the basis of the learned contents.

Steps S9-1 to S9-3 may be repeated with different descriptor combinations. For example, other kinds of metal atoms are added to increase the number of descriptor combinations. In addition, the number of descriptor combinations when different kinds of metal atoms are positioned at substitution sites is increased. The number of combinations is increased in such a manner and Steps S9-1 to S9-3 are repeated, whereby training data is accumulated, increasing the accuracy of predicted values. When only data on crystal structures with a large c-axis length is selected as training data and a learning model in a subsequent step is built, unknown crystal structures may be easily searched for.

After that, in Step S10, the descriptor combinations created in Step S9 or Step S9-1 are added to the Gaussian process regression model 1 to generate a Gaussian process regression model 2. Thus, a search space of the Gaussian process regression model 2 is generated on the basis of the descriptor combinations.

In Step S11, in the search space generated in the previous step, descriptors that provide the optimum value of c-axis length are searched for using the Gaussian process regression model 2. In Step S11, descriptors and c-axis lengths are output, and the user can identify a crystal structure with the maximum c-axis length among them. The details of priority of descriptors suggested in this step will be described later.

In Step S12, the suggested descriptors are converted into data in a format for an optimization program typified by VASP. The user can identify a crystal structure on the basis of the descriptors output in Step S11; thus, the conversion can be performed as appropriate.

In Step S13, c-axis lengths are calculated by an optimization program typified by VASP using the data in a format for a calculation program, which is obtained in the previous step, and solutions are compared with ground truth data. Descriptors and c-axis length data when the calculation results agree with the ground truth data can be used as training data. Checking solutions by comparison with ground truth data by calculation can also be referred to as determination.

The above-described data acquired by VASP is added as part of new training data, whereby the Gaussian process regression model 2 is updated. Adding new training data to update the Gaussian process regression model 2 increases the accuracy of the Gaussian process regression model 2. Repeating the update processing allows a search for an optimum solution with higher accuracy. Through the above procedure, the learning model can be efficiently generated. Here, an efficient learning model refers to a learning model with which output values with higher accuracy can be obtained using a smaller amount of training data.

As in the method for searching for a crystal structure of this embodiment, only part of the c-axis lengths determined by information for determining c-axis lengths are calculated by first-principles calculation, so that the load of calculation can be reduced.

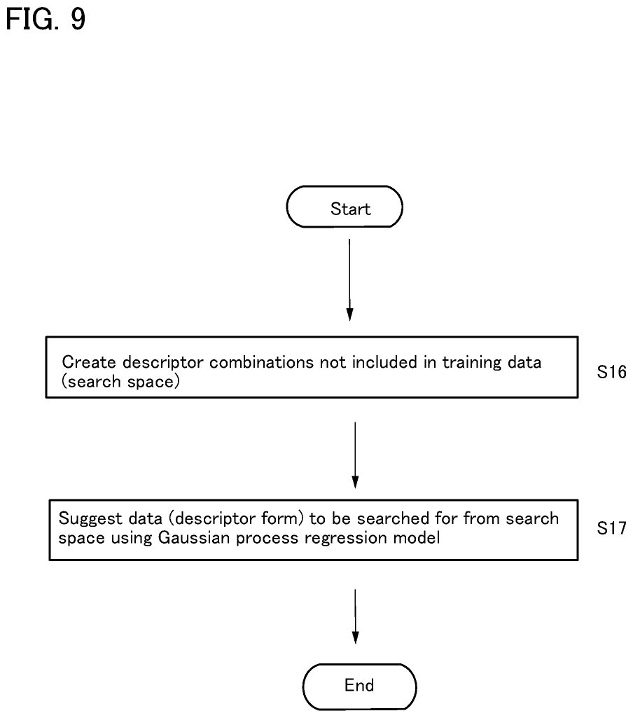

Next, an example of processing for optimizing descriptors that provide the optimum value of c-axis length in the method for searching for a crystal structure will be described with reference to FIG. 9. The flowchart shown in FIG. 9 includes Steps S16 and S17.

In Step S16, descriptor combinations are created, and a search space of a Gaussian process regression model is generated on the basis of the descriptor combinations.

In Step S17, in the search space generated in the previous step, descriptors that provide the optimum value of c-axis length are searched for using the Gaussian process regression model. The priority of descriptors suggested in this step is determined in consideration of mean values and variances of the search results. A mean value of the search results refers to the center of prediction, and a variance thereof refers to the degree of prediction dispersion. When descriptors have approximately equal mean values, a descriptor with a larger variance is prioritized. Through this step, descriptors and data on respective mean values, variances, and suggestion scores are output. A suggestion score can also be referred to as prediction accuracy.

Through the above procedure, learning of the Gaussian process regression model is performed using as few descriptors selected using LASSO as possible; thus, a new maximum value with a large variance can be suggested as a predicted value.

Through the above steps, descriptors that provide the optimum value of a c-axis length can be optimized.

As described above, for example, a crystal structure and the kind of substitution element when the c-axis length is the maximum can be predicted in the search space. With the prediction result and prediction process, the optimum descriptors for predicting a c-axis length can be determined. With the optimized descriptors, a crystal structure and the kind of substitution element when a change in c-axis length between the first state and the second state is small can be predicted.

Specifically, for example, a plurality of crystal structures with different Li concentrations of a positive electrode active material in which the first substitution element is positioned at the first substituent site are calculated, whereby the Li concentration with which the c-axis length is the maximum, the Li concentration with which the c-axis length is the minimum, and the amount of change in c-axis length can be predicted. The calculation is performed under various conditions of substitution sites and substitution elements, so that a crystal structure that has a small change in c-axis length during charge and discharge can be predicted.

Here, in the calculation of an NCM crystal structure, it can be assumed that the c-axis length is the maximum with a Li atomic concentration of 33.3 atomic %. In the case where the Li atomic concentration with which the c-axis length of NCM is the maximum is set to 16.7 atomic % and 16.7 atomic % is regarded as the second state, the amount of change in c-axis length during charge and discharge can be simplified as a difference between the c-axis length in the first state where the Li atomic concentration is 33.3 atomic % and the c-axis in the second state where the Li atomic concentration is 16.7 atomic %. In such a manner, the Li atomic concentration with which the c-axis length is the maximum and the Li concentration with which the c-axis length is predicted to be small within the usage range of a secondary battery are calculated to search for a crystal structure, whereby the speed of searching for a crystal structure can be increased. The number of calculation items is not limited to two and may be three including the third state (the Li atomic concentration is a given value) or four or more.

When the above-described method for searching for a crystal structure allows prediction and identification of a crystal structure that has a small change in a c-axis length during charge and discharge, an ideal positive electrode active material is determined. The compounding ratio of an actual positive electrode active material is adjusted such that the crystal structure of the positive electrode active material can be obtained, whereby an ideal secondary battery can be fabricated.

For example, in the case of a unit of 360 atoms, three times of the number of atoms is 1080 and one tenth of the number of atoms is 108; thus, the atomic concentration can be calculated approximately in percentage. Therefore, a positive electrode active material having a target crystal structure can be fabricated using separately weighed materials containing respective elements.

This embodiment can be freely combined with any of the other embodiments.

### Embodiment 4

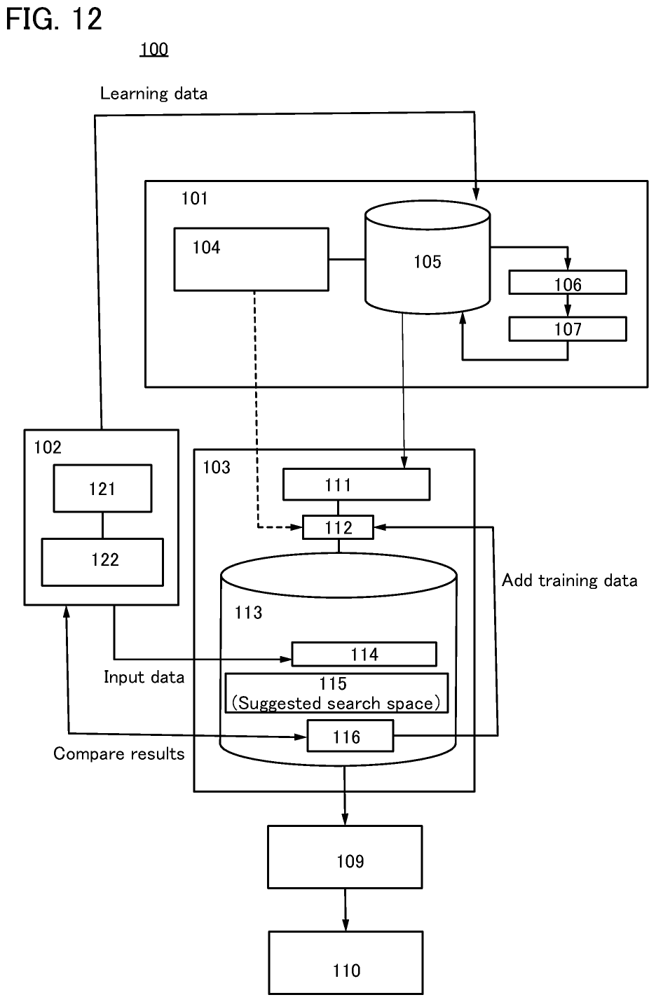

In this embodiment, the entire structure of a solution search processing device, which is an example of a system for executing the method for searching for a crystal structure of Embodiment 3, will be described with reference to FIG. 12. FIG. 12 illustrates an example of the entire structure of a solution search processing device. As illustrated in FIG. 12, a solution search processing device 100 includes an arithmetic unit 101, a comparator unit 102, and an inference unit 103.

At least a program for generating a regression model is installed in the arithmetic unit 101. By executing a program for generating a regression model typified by LASSO, a learning unit 104 functions. The learning unit 104 generates a learning model with the use of learning data (also referred to as training data) stored in a learning data storage unit 105. The learning data may be acquired from a free library or extracted from a known data book. A user can appropriately select learning data in accordance with a learning model employed. An example of learning data is training data called supervised data. For example, in the case of searching for a crystal structure in which substitution elements are positioned at m sites (m is an integer greater than or equal to 0), information on substitution element site(s) of the crystal structure is converted into a descriptor. In addition, the characteristic values of the substitution element are converted into descriptors. The data containing them is used as learning data. In the case where learning data, which contains descriptors, is subjected to conversion using a conversion program and stored in the learning data storage unit 105, the learning unit 104 has a function of a descriptor generation means.

The arithmetic unit 101 may include a calculation unit 106 for calculating the contribution of descriptors used as learning data and a descriptor extraction unit 107 for extracting descriptors on the basis of calculated contribution. The descriptor extraction unit 107 enables increased inference accuracy. The descriptor extraction unit 107 can also function as a descriptor generation means.

The inference unit 103 includes at least a descriptor input unit 111, an execution unit 112, and a storage unit 113. The descriptor input unit 111 also functions as a descriptor generation means because it uses descriptors selected by the learning unit 104 and the descriptor extraction unit 107. In the storage unit 113, past calculation results 114 and a current object 115 are stored. The user can input the past calculation results 114, and not only calculation results the user has obtained by calculation in the past but also selected known data can be stored. The past calculation results 114 serve as training data in the execution unit 112, and accumulating past calculation results allows a solution with high accuracy to be obtained. A large amount of past calculation results are not always necessary; it is important to obtain a solution even with a small amount of accumulation of past calculation results. The current object, which is new information obtained with new descriptors, can be referred to as a suggested search space, and is object data for obtaining a solution expected to be obtained by the user.

In the execution unit 112, at least a learning model generation program is installed. The execution unit 112 includes a learning model having learned using a Gaussian process regression model and functions as a second learning unit. With the input of the descriptors, which are new data, to the learned learning model obtained by the arithmetic unit 101, the inference unit 103 performs simulation processing. The execution unit 112 performs simulation processing in parallel and outputs search results 116 (also referred to solutions). The output data is made to be data in a format that can be visually recognized on the display unit 110 by the user via a display control unit 109.

The search results 116 are listed in order of priority of a plurality of suggested descriptors. Specifically, top N descriptors with high priority (e.g., top five descriptors) and their mean values, variants, and suggestion scores are output data. A mean value of the search results 116 refers to the center of prediction, and a variance thereof refers to the degree of prediction dispersion. A suggestion score can be calculated on the basis of a variant and a mean and can also be referred to as prediction accuracy. In the case where a large variant and a large mean are obtained as results, the characteristic values of an unknown crystal structure might be obtained as results; thus, the large variant and the large mean are desirable as search results.

When the user performs calculation in the comparator unit 102, the obtained search results 116 (solutions) can be compared with ground truth data and checked. The data calculated in the comparator unit 102 can be used as training data; therefore, adding training data to the execution unit 112 allows a solution with a large variant to be obtained also for the next object. Checking solutions by comparison with ground truth data by calculation in the comparator unit 102 by the user can also be referred to as determination.

The comparator unit 102 includes a calculator 121 for calculation, and for example, software 122, which can perform first-principles calculation, is installed in the comparator unit 102. As the calculator 121 in the comparator unit 102, a general data processing device including an input unit (keyboard), a CPU (or a GPU), a storage unit, or a memory can be used. The data processing device may be a desktop computer, a laptop computer, a tablet, or a server system. Alternatively, a general data processing device and a large computer having a parallel processing function may be connected via a network to perform calculation. The computer includes at least one processor and a memory. In the comparator unit 102, the user inputs data thereto, performs calculation with the use of the software 122, or creates training data by the calculation. The calculation results obtained when the user performs calculation using the calculator 121 may be stored as the past calculation results 114, in the storage unit 113 of the inference unit 103.

Although the arithmetic unit 101, the comparator unit 102, and the inference unit 103 are separately illustrated in FIG. 12 for explanation, one embodiment of the present invention is not particularly limited thereto and calculation may be performed using a common calculator. As a common calculator, a large computer having a parallel processing function may be used. It is needless to say that calculation may be performed by two or more calculators. Alternatively, as a common calculator, a work station configured by connecting a plurality of calculators may be used.

Although the learning data storage unit 105 and the storage unit 113 are separately illustrated in FIG. 12 for explanation, one embodiment of the present invention is not particularly limited thereto, and data can be stored in a common storage unit. It is needless to say that data may be stored in three or more storage units.

FIG. 12 illustrates an example where the arithmetic unit 101, the comparator unit 102, and the inference unit 103 are connected to each other; however, one embodiment of the present invention is not particularly limited thereto, and they may be connected to each other via the network. Further, a communication unit may be added to the solution search processing device 100 so as to be connected to a cloud server system or a data processing device.

This embodiment can be freely combined with any of the other embodiments.

### Embodiment 5

Although the example of using the Gaussian process regression model is described in Embodiment 3, one embodiment of the present invention is not particularly limited thereto; a neural network where a plurality of processing layers are hierarchically connected may be used.

In the case where neural network processing is performed, hardware including memories adequate for accumulating learning data and capable of sufficient arithmetic processing is needed. The arithmetic unit and the inference unit described in Embodiment 4 may be used to perform neural network processing. The learning data can be prepared using the calculator and the software in the comparator unit described in Embodiment 4.

A program of the software executing an inference program for the neural network processing can be described in a variety of programing languages typified by Python, Go, Perl, Ruby, Prolog, Visual Basic, C, C++, Swift, Java (registered trademark), and .NET. The application may be formed using a framework typified by Chainer (it can be used with Python), Caffe (it can be used with Python and C++), and TensorFlow (it can be used with C, C++, and Python). For example, the algorithm of LSTM is programmed with Python, and a central processing unit (CPU) or a graphics processing unit (GPU) is used. An integrated chip of a CPU and a GPU is sometimes referred to as an accelerated processing unit (APU), and an APU chip can also be used. An IC with an AI system (also referred to as an inference chip) may be used. The IC with an AI system is sometimes referred to as a circuit performing neural network calculation (a microprocessor).

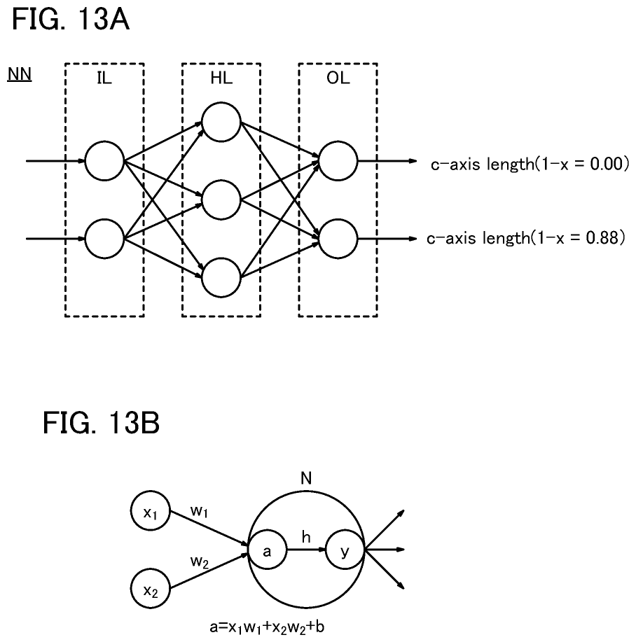

Description will be made below with reference to FIGS. 13A and 13B.

In this embodiment, a learning model is built by making it learn a plurality of pieces of data obtained by first-principles calculation (the data can also be called as first-principles calculation results) and data on existing descriptors or original descriptors.

In this embodiment, the learning is performed in such a manner that optimum weight and bias are set for each node at which neurons are connected, to create a learning model. A user appropriately selects and uses a framework from among Chainer, Caffe, and TensorFlow. The number of intermediate layers is larger than or equal to three and the number of hidden layers is larger than or equal to 200. The user appropriately selects an optimizer from among SGD, Momentum, RMSProp, Adam, and NAdam and uses it. As learning data, existing descriptors or original descriptors are used, and a c-axis length is made to be learned as a ground truth label. For the learning, data subjected to linear interpolation and normalization is used.

FIG. 13A and FIG. 13B show an example of operation in neural network processing. As illustrated in FIG. 13A, neural network processing NN can be composed of an input layer IL, an output layer OL, and a middle layer (hidden layer) HL. The input layer IL, the output layer OL, and the middle layer HL each include one or more neurons (units). Note that the middle layer HL may be composed of one layer or two or more layers. Neural network processing including two or more middle layers HL can also be referred to as deep neural network (DNN), and learning using deep neural network processing can also be referred to as deep learning.

Input data is input to each neuron of the input layer IL, output signals of neurons in the previous layer or the subsequent layer are input to each neuron of the middle layer HL, and output signals of neurons in the previous layer are input to each neuron of the output layer OL. Note that each neuron may be connected to all the neurons in the previous and subsequent layers (full connection), or may be connected to some of the neurons.

FIG. 13B shows an example of an operation with the neurons. Here, a neuron N and two neurons in the previous layer which output signals to the neuron N are shown. An output x₁ of the neuron in the previous layer and an output x₂ of the neuron in the previous layer are input to the neuron N. Then, in the neuron N, a total sum x₁w₁+x₂w₂ of the product of the output x₁ and a weight w₁(x₁w₁) and the product of the output x₂ and a weight w₂(x₂w₂) is calculated, and then a bias b is added as necessary, so that a value a=x₁w₁+x₂w₂+b is obtained. Then, the value a is converted with an activation function h, and an output signal y=h(a) is output from the neuron N.

In this manner, the operation with the neurons includes the operation that sums the products of the input data and the weights, that is, a product-sum operation. This product-sum operation can be performed by a product-sum operation circuit including a current supply circuit, an offset absorption circuit, and a cell array. In addition, signal conversion with the activation function h can be performed by a hierarchical output circuit. In other words, the operation of the middle layer HL or the output layer OL can be performed by an operation circuit.

The cell array included in the product-sum operation circuit is composed of a plurality of memory cells arranged in a matrix.

The memory cells each have a function of storing first data. The first data is data corresponding to the weight between the neurons of the neural network processing. In addition, the memory cells each have a function of multiplying the first data by second data that is input from the outside of the cell array. That is, the memory cells have a function of a memory circuit and a function of a multiplier circuit.

Note that in the case where the first data is analog data, the memory cells have a function of an analog memory. Alternatively, in the case where the first data is multilevel data, the memory cells have a function of a multilevel memory.

The multiplication results in the memory cells in the same column are summed up. Thus, the product-sum operation of the first data and the second data is performed. Then, the results of the operation in the cell array are output to the hierarchical output circuit as third data.

The hierarchical output circuit has a function of converting the third data output from the cell array in accordance with a predetermined activation function. An analog signal or a multilevel digital signal output from the hierarchical output circuit corresponds to the output data of the middle layer or the output layer in the neural network processing NN.

As the activation function, a sigmoid function, a tan h function, a softmax function, a ReLU function, or a threshold function can be used, for example. The signal converted by the hierarchical output circuit is output as analog data or multilevel digital data (data D_{analog}).

In this manner, one of the operations of the middle layer HL and the output layer OL in the neural network processing NN can be performed by one operation circuit. Note that the product-sum operation circuit and the hierarchical output circuit included in the operation circuit [k] (k is an integer greater than or equal to 1 and less than or equal to N) are denoted by the product-sum operation circuit [k] and the hierarchical output circuit [k], respectively. The analog data or the multilevel digital data output from the operation circuit [k] is denoted by data D_{analog}[k].

Analog data or multilevel digital data output from a first operation circuit is supplied to a second operation circuit as the second data. Then, the second operation circuit performs an operation using the first data stored in the memory cells and the second data input from the first operation circuit. Thus, operation of neural network processing composed of a plurality of layers can be performed.

To obtain the c-axis length of a crystal structure that is intended to be found, a predicted value of c-axis length is obtained with the use of a learning model to which the data on descriptors corresponding to the crystal structure is input. In this embodiment, assuming that a positive electrode active material is LiₓNi_{0.89}Co_{0.05}Mn_{y}M_{z}, the c-axis length of its crystal structure is calculated. M is a substitution element and specifically is a transition metal.

For example, a learning model obtained using, as learning data, data typified by a Li concentration x and the kind, valence, atomic weight, electronegativity, first ionization energy, atomic volume, atomic radius, and ionic radius of the substitution element M is used and each data is input as an input A; as a result, a predicted value of c-axis length when 1−x=0, i.e., the case of Liₓ (x=1) can be output. As shown in FIG. 13A, when each data is input as an input B, a predicted value of c-axis length of the case of Liₓ (x=0.12) can be output.

Creating the above model allows prediction of the c-axis length of the crystal structure corresponding to certain descriptors.

This embodiment can be freely combined with any of the other embodiments.

### Embodiment 6

In this embodiment, an example will be described below in which a learning model is built using Random forest as the learned learning model 200 in Embodiment 1 to predict a c-axis length with high accuracy.

Random forest is a learning algorithm for improving generalization capability by integrating a plurality of weak learners using Decision trees. When Random forest is used for a set of nonlinear data, high-accuracy predicted value can be obtained in some cases.

As in Embodiment 1, the structure U1 shown in FIG. 1, whose basic crystal structure is an NCM crystal structure, is converted into a descriptor, the characteristic values of metal atoms are also converted into descriptors, and the descriptors are input to the learned learning model 200, so that an output including a predicted value, specifically, a c-axis length in this embodiment is obtained.

The use of Random forest enables a difference from the value calculated using VASP to be smaller than that obtained using a Gaussian process regression model in Embodiment 3. However, in the case of employing a learning model using Random forest, it is difficult to calculate a variant to capture characteristics other than those in learning data, unlike the case of employing a Gaussian process regression model. Thus, a learning model using Random forest is employed as a method for predicting a c-axis length with high accuracy.

This embodiment can be freely combined with any of the other embodiments.

### Example

In this example, a crystal structure was searched for according to the method for searching for a crystal structure shown in FIG. 7.

In Step S1, the calculation model of an NCM crystal structure shown in FIG. 5 was created.

In Step S2, one to three substitution sites at which manganese is substituted by magnesium were selected from among the substitution sites 1, 2, 3, 4, 5, and 6 in FIG. 5.

In Step S3, the c-axis length when manganese at the substitution site selected in the previous step is substituted by magnesium, zinc, or aluminum was calculated using VASP. FIG. 10A shows calculation results up to here. In this example, FIG. 10A lists the following five conditions in order in the column direction: the c-axis length when magnesium is positioned at the second substitution site, the c-axis length when magnesium is positioned at the third substitution site, the c-axis length when zinc is positioned at the fifth and sixth substitution sites, the c-axis length when zinc is positioned at the first to third substitution sites, and the c-axis length when aluminum is positioned at the first and second substitution sites. In FIG. 10A, labels of parameters are shown in the first row, for easy understanding.

In Step S4, magnesium, which is a substitution element, and substitution sites were converted into descriptors expressing them. Specifically, substitution sites were expressed using “0” representing being not substituted or “1” representing being substituted. For example, the case where a substitution site is the second substitution site was expressed by a descriptor [0, 1, 0, 0, 0, 0], and the case where substitution sites are the fifth and sixth substitution sites was expressed by a descriptor [0, 0, 0, 0, 1, 1]. FIG. 10B shows the case where part of data in FIG. 10A was converted into descriptors. In addition, magnesium, zinc, and aluminum were converted into the characteristic values, specifically, their valences, atomic weights, electronegativities, first ionization energies, atomic volumes, atomic radii, and ionic radii in this example. FIG. 10C shows the descriptors and c-axis lengths after the conversion. In FIGS. 10B and 10C, labels of parameters are shown in the first row, for easy understanding.

In Step S5, the descriptors obtained in the previous step and the c-axis length data acquired using VASP in Step S3 were combined so as to be a row of data group, it was input as learning data to a regression model, and learning of the regression model was performed so that a c-axis length was predicted from the descriptors. As the regression model, LASSO was used. FIG. 10C shows the learning data. Although labels of parameters are shown in the first row in FIG. 10C for easy understanding, row data without the labels or matrix data, which is a set of row data, was input to the regression model. Some pieces of data on the valences, atomic weights, electronegativities, first ionization energies, atomic volumes, atomic radii, and ionic radii of Al, Sc, Ti, V, Cr, Fe, Cu, Zn, Ga, and Ge as substitution elements were selected by a user and made to be learned. In this example, 41 kinds of data were used.

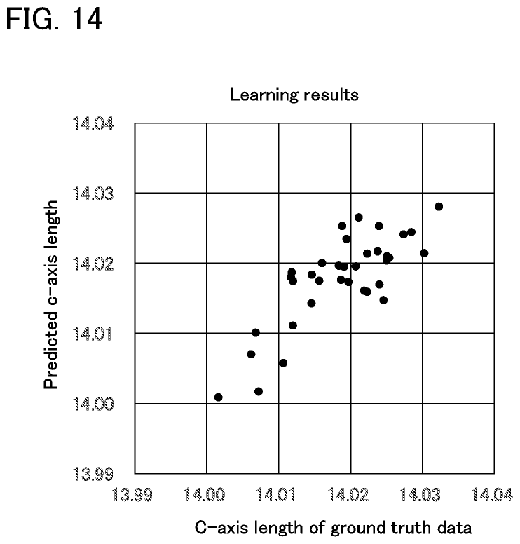

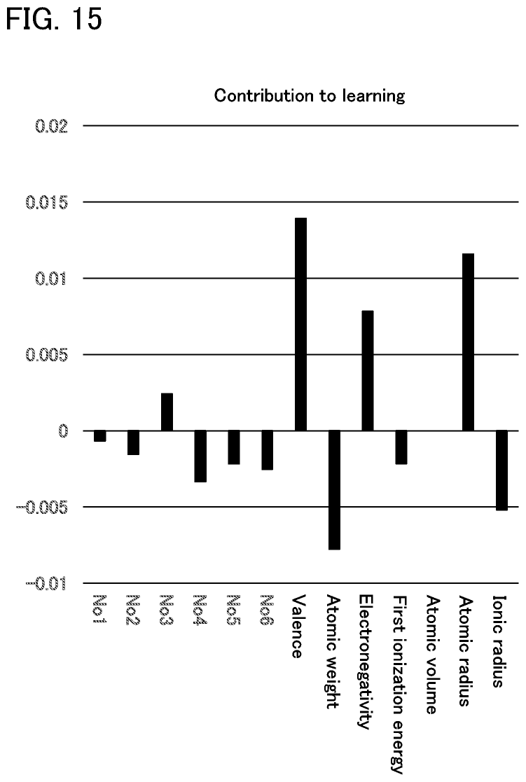

In Step S6, the learning result of the regression model and descriptors contributing to the learning were determined. Specifically, c-axis lengths predicted from descriptors were compared with the c-axis length of the ground truth data obtained by the calculation in Step S3, and descriptors having an absolute value of contribution to the learning of greater than or equal to 0.001 were extracted. In this example, the descriptors in FIG. 11B were extracted from the descriptors in FIG. 11A. The c-axis lengths shown in FIGS. 11A and 11B are the values obtained by calculation performed using VASP by the user, i.e., ground truth data. FIG. 14 shows the results of comparison between the c-axis lengths predicted using the regression model and the c-axis length of the ground truth data. FIG. 15 shows contribution to the learning of the descriptors. In this example, as descriptors contributing to the learning, substitution sites, a valence, atomic weight, electronegativity, first ionization energy, an atomic radius, and an ionic radius were extracted.

In Step S7, training data in a format for the Gaussian process regression model 1 was created using the descriptors extracted in the previous step. In this example, 41 kinds of combinations of training data were made to be learned. Although labels of parameters are shown in the first row in FIG. 11B for easy understanding, data in the second and subsequent rows correspond to the training data. For example, data except the c-axis length in the second row in FIG. 11B can be referred to as descriptors, and the data in the second row can be referred to as information on a combination of a c-axis length and descriptors because the c-axis length is not a descriptor. FIG. 11B shows five kinds of combinations (combinations of a c-axis length and descriptors), which are part of the training data.

In Step S8, learning of the Gaussian process regression model 1 was performed on the basis of the training data in a format for the Gaussian process regression model 1, which had been created in the previous step.

In Step S9, combinations of descriptors other than the training data in the previous step were created, and the combinations of descriptors and the c-axis lengths calculated using VASP were made to be learned. A search space of the Gaussian process regression model 1 was generated on the basis of the combinations of descriptors and the c-axis lengths.

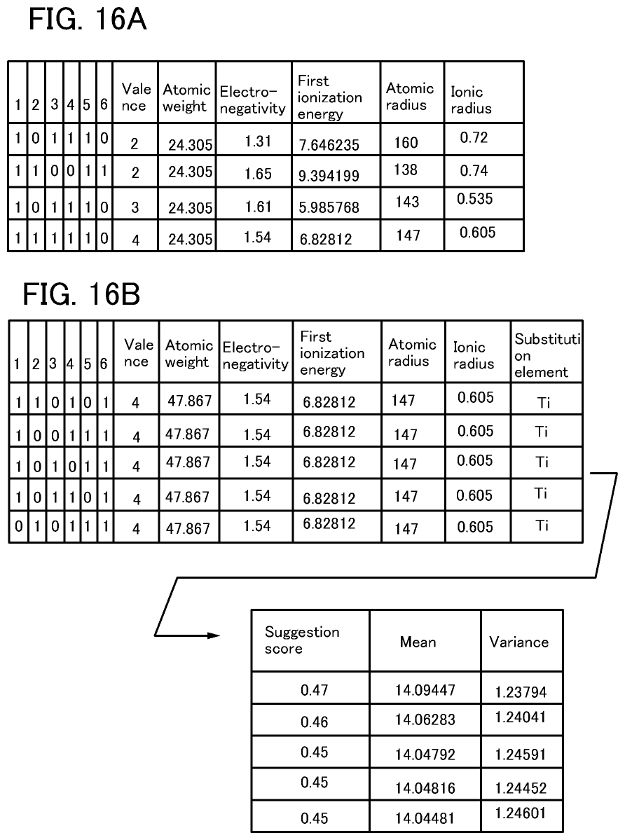

Specifically, combinations of descriptors when manganese is substituted by a substitution element at four or five substitution sites were created, the c-axis lengths of the cases of part of the combinations of descriptors were calculated, and the c-axis lengths and the part of the combinations of descriptors were made to be learned. In this example, FIG. 16A shows four kinds of combinations (combinations of a c-axis length and descriptors). The training data used before Step S9 were only data when substitution is performed at one to three sites, which were prepared as in the example shown in FIG. 10C.

In Step S9, combinations of descriptors when substitution is performed at four or five substitution sites were created, the c-axis lengths of the cases were calculated by VASP, and new training data different from the training data used before Step S9 was created. Adding new training data in such a manner may bring an output result having not been obtained by learning performed up to that point. This can be expressed as expansion of the search space. In contrast, a general learning model and simulation software do not bring an output exceeding set calculation conditions; therefore, the search space does not expand.

In Step S10, the combinations of descriptors created in the previous step were added to the Gaussian process regression model 1 to generate the Gaussian process regression model 2. This generates a search space of the Gaussian process regression model 2 on the basis of the combinations of descriptors. Since the new training data was added, the search space of the Gaussian process regression model 2 became larger than the search space of the Gaussian process regression model 1.

For the Gaussian process regression models, a probability model using a Gpytorch Gaussian process was employed. A probability model using a Gpytorch Gaussian process can be employed as software. There is no particular limitation on a probability model as long as it employs a Gpytorch Gaussian process; for example, a Bayesian network model may be employed.

In Step S11, in the search space generated in the previous step, descriptors that provide the optimum value of c-axis length were searched for using the Gaussian process regression model 2. In this step, descriptors and mean values were output from the search space of the Gaussian process regression model 2. Five rows of descriptors and mean values in FIG. 16B are listed in order of decreasing suggestion score. The values except means, suggestion scores, and variants shown in FIG. 16B are all descriptors. A mean represents the average value of c-axis lengths.

In the case where a Gaussian process regression model is used as a learning model, a predicted value is output as three indicators of a mean, a suggestion score, and a variant. A variant represents the degree of prediction dispersion, and a mean represents the center of predicted values. In the case where a variant is large, there may be a characteristic that has not been included in learning data. In the case where a mean is large, a large c-axis length might be obtained. A suggestion score is an indicator showing prediction quality.

Although FIG. 16B shows only information on the case where a substitution element is titanium, information on the cases where substitution elements are other transition metals are also included in the search space. The crystal structure suggested with a suggestion score of 0.47 in FIG. 16B by the method for searching for a crystal structure of this example is expressed as LiₓNi_{0.89}Co_{0.05}Mn_{y}Ti_{z}, which is obtained by optimizing a structure including titanium at the sites of No. 1, 2, 4, and 6 in FIG. 5, and manganese at the sites of No. 3 and 5 in FIG. 5.

In Step S12, the descriptors suggested in the previous step were converted into data in a format for VASP. Specifically, for example, descriptors when manganese at the substitution sites shown in FIG. 16B is substituted by titanium were converted into data in a format for VASP.

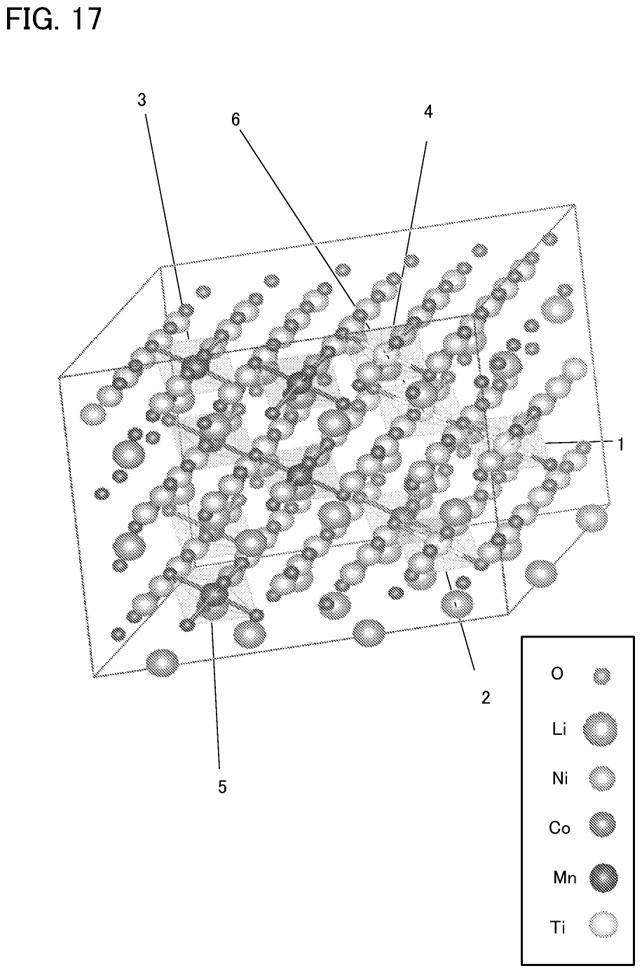

In Step S13, a c-axis length was calculated by VASP using the data in a format for VASP obtained in the previous step, and the solution was compared with ground truth data. When VASP calculation was performed on the result with a suggestion score of 0.47, the c-axis length was 1.4022 nm. Note that the obtained predicted value of the c-axis length does not need to agree with the ground truth data, and it is important to identify a crystal structure when a large mean and a high variant are output. FIG. 17 is a diagram showing the descriptor output using VESTA.

A combination of the c-axis length obtained using VASP and descriptors with which the c-axis length can be obtained is added as training data, whereby a learning model with which a high-accuracy solution can be obtained can be generated.

In the method for searching for a crystal structure of this example, only the c-axis lengths of crystal structures in which substitution is performed at some specific substitution sites are calculated by first-principles calculation; thus, a result with a relatively high accuracy can be obtained with a relatively small load, compared with the case where the c-axis lengths of all possible crystal strictures are calculated by first-principles calculation. This probably enables an efficient search for a crystal structure.

Although the user created all training data with the use of VASP in this example, without particular limitation, simulation software other than VASP may be used to create data to be used as training data.

This application is based on Japanese Patent Application Serial No. 2021-114509 filed with Japan Patent Office on Jul. 9, 2021 and Japanese Patent Application Serial No. 2021-146856 filed with Japan Patent Office on Sep. 9, 2021, the entire contents of which are hereby incorporated by reference.

What is claimed is:

1. A method for predicting a c-axis length of a crystal structure of a lithium compound containing cobalt, nickel, and manganese, comprising:
a step of preparing a descriptor including n values (n is an integer greater than or equal to 0) obtained by converting a crystal structure of the lithium compound in which the manganese at any one or more of n sites is substituted by a metal atom among crystal structures of the lithium compound into binary data and a characteristic value of the metal atom;
a step of inputting the descriptor into a learned learning model; and
a step of outputting a predicted value of c-axis length of an optimized crystal structure and a descriptor corresponding to the optimized crystal structure as an output value of the learning model.

2. The method for predicting a c-axis length of a crystal structure of a lithium compound, according to claim 1, wherein the learning model is built using a Gaussian process regression model.

3. The method for predicting a c-axis length of a crystal structure of a lithium compound, according to claim 1, wherein the learning model is built using a convolutional neural network.

4. The method for predicting a c-axis length of a crystal structure of a lithium compound, according to claim 1, wherein the crystal structure is a layered rock-salt structure.

5. A method for building a learning model for predicting a c-axis length of a crystal structure of a lithium compound containing cobalt, nickel, and manganese, comprising:
a step of acquiring, as a descriptor, n values obtained by converting a crystal structure of the lithium compound in which the manganese at any one or more of n sites (n is an integer greater than or equal to 0) is substituted by a metal atom among crystal structures of the lithium compound into binary data; and
a step of adding a characteristic value of the metal atom to the descriptor,
wherein a c-axis length of a crystal structure in which manganese at one of n sites is substituted by the metal atom is used as part of training data.

6. The method for building a learning model, according to claim 5, wherein the learning model is built using a Gaussian process regression model.

7. The method for building a learning model, according to claim 5, wherein the learning model is built using a convolutional neural network.

8. The method for building a learning model, according to claim 5, wherein the c-axis length is calculated by first-principles calculation.

9. The method for building a learning model, according to claim 5, wherein a descriptor having an absolute value of contribution to learning of greater than or equal to 0.001 is extracted among characteristic values of the metal atom, using a regression model.

10. A system for predicting a crystal structure, comprising:
a crystal structure setting unit that determines a crystal structure containing lithium, cobalt, nickel, and manganese;
a descriptor generating unit that generates a descriptor including a kind of a metal atom and information on a substitution element site in a crystal structure in which manganese at m sites (m is an integer greater than or equal to 0) is substituted by the metal atom;
a first-principles calculation unit that calculates a c-axis length of a crystal structure in which the substitution element is positioned, by first-principles calculation; and
a learning unit that performs learning using a first-principles calculation result as training data,
wherein a learning result obtained by the learning unit includes a maximum c-axis length.
